(19) United States
(12) Patent Application Publication
(10) Pub. No.: US 2023/0340344 A1
(43) Pub. Date: Oct. 26, 2023

(54) Rotary Kiln Catalytically Enhanced Oxy-Fuel Gasification and Oxy-fuel Combustion (RK-GEN) System, Method, or Apparatus

(71) Applicant: Net Zero Global Group LLC, Trinidad, CO (US)

(72) Inventor: Thomas Boyd, Trinidad, CO (US)

(21) Appl. No.: 18/137,701

(22) Filed: Apr. 21, 2023

Related U.S. Application Data
(60) Provisional application No. 63/333,451, filed on Apr. 21, 2022.

(51) Int. Cl. C10J 3/00; F23L 7/00; C10J 3/84; C10K 1/00; C01B 3/56; C01B 21/04; B01D 53/00; B01D 53/26

(52) U.S. Cl. CPC C10J 3/005; F23L 7/007; C10J 3/84; C10K 1/005; C01B 3/56; C01B 21/0438; B01D 53/002; B01D 53/265; F23J 15/04

(57) ABSTRACT

The disclosure relates to a rotary kiln catalytically enhanced oxy-fuel gasification and oxy-fuel combustion system—power plant including an air separation unit arranged to separate oxygen from air and produce a stream of substantially pure liquid oxygen; rotary kiln gasifiers to convert municipal solid waste, biomass, alternate wastes, coal, or hydrocarbon fuels into a synthesis gas in the presence of oxygen, carbon dioxide, high temperature steam and lime catalysts; an oxy-fuel fired boiler arranged to combust synthesis gas, in the presence of substantially pure oxygen gas, to produce an exhaust gas comprised of water and carbon dioxide; and a carbon dioxide removal unit arranged to recover carbon dioxide gas from the exhaust gas, recycle a portion of the recovered carbon dioxide gas for use in the rotary kiln gasifier, and liquefy the remainder of the recovered carbon dioxide gas for removal from the plant. In this new plant, the carbon dioxide removal unit is thermally integrated with the air separation unit or alternately the liquid oxygen storage and supply system by directing a stream of liquid oxygen to the carbon dioxide removal unit to liquefy the recovered carbon dioxide gas, the liquid oxygen thereby evaporating and forming cold oxygen gas which is heated prior to consumption in the rotary kiln and oxy-fuel fired boiler.

### CROSS-REFERENCE TO RELATED APPLICATIONS

This application is a non-provisional application of, and claims the benefit of, U.S. Provisional Application No. 63/333,451, filed on Apr. 21, 2022, the disclosure of which is incorporated by reference in its entirety.

### BACKGROUND

### Technical Field

The present disclosure relates to improved omnivorous oxy-fuel gasification. More particularly, and not by way of limitation, the present disclosure is directed to a system, method, or apparatus for an oxy-fuel combustion power plant, or a multi-fuel capable gasification system, and an electrical power generating plant, with complete carbon dioxide (CO₂) recovery.

### Description of Related Art

Pyrolysis/gasification systems must be able to contend with the conversion of fuels whether solids, liquids, or gases (or combinations of these three fuel types) to produce an end product gas (pyrolysis gas, producer gas or syngas) that meets the desired end use criteria. There are four general process categories associated with the non-combustion conversion of waste fuels, biomass, or fossil fuels to a gas:
Pyrolysis—oxygen-starved conversion to produce a raw pyrolysis gas mixture [includes H₂O, CO, CO₂, H₂, H₂S, HCl, CH₄, C₂ and C₃ hydrocarbons, light aromatics, benzene, toluene, and xylene (BTX)]
Air-blown gasification—air gasification to produce a raw producer gas mixture [includes H₂O, CO, H₂, CH₄, CO₂, NOₓ, HCN, HCl, H₂S, COS, NH₃, Dioxins, Furans, etc.]
Plasma gasification (plasma pyrolysis)—uses an electric arc to catalyze organic matter and produce ionized gases forming a raw producer gas mixture [includes CO, H₂, N₂, H₂O, H₂S, CH₄, COS, HCl and potentially Dioxins, Furans, etc.]
Oxygen-blown (oxy-fuel) gasification—controlled (sub-stoichiometric) oxygen gasification to produce a raw syngas mixture [includes CO, H₂, CO₂, HCl, H₂S, COS, CH₄, and H₂O]

By comparison, combustion of waste fuels, biomass, or fossil fuels produces an array of atmospheric pollutant emissions (post combustion: NOₓ, SOₓ, CO₂, H₂O, CO, VOC, PM₁₀, Hg, etc.) that must be dealt with to meet BACT (best available control technology) or MACT (maximum available control technology) standards. Additionally, with the possible exception of biomass, a hazardous bottom-ash (residue) and fly-ash residue must be dealt with.

Gasification processes differ by technology, but are based on the following factors:
Design of the gasifier
Gasification temperature and pressure
Gasifier residence times
Heating: Auto-thermal (internal) or Allothermal (external)
Gasification environment (fuel/catalytic additives/oxygen/steam/CO₂)

Within the four pyrolysis/gasification technology process categories, there are a large number of process variations based on pressures, temperatures, catalysts, and gasification conditions. Excluding plasma gasification, these approaches can be either allothermal or autothermal (externally heated endothermic or internally heated exothermic processes). Allothermal systems typically use a portion of the gas produced to generate sufficient heat to support the temperature conditions necessary for system operation, usually via an external burner. Autothermal systems produce sufficient heat within the process to support sustained operation.

Most Pyrolysis processes produce, in addition to a pyrolysis gas, a “char” containing unconverted carbon, ash products, heavy metals (depending upon the feedstock), and tars. These systems normally have a flare or smokestack.

Most air-blown gasification processes produce, in addition to the producer gas, fly-ash, bottom ash or a glass residue, and other atmospheric pollutant emissions that must be controlled. These systems normally have a smokestack.

Plasma gasification (plasma pyrolysis)—utilizes a pressurized inert gas (nitrogen) that is ionized when passing through the plasma created by the arc. The waste having been pre-screened to remove bricks, stones, metals; is dried and shredded before being fed into the reactor. There it is heated, melted, and vaporized. At the extreme conditions (extremely high temperatures >3,600° F.) molecular dissociation occurs. Feedstock components are separated into individual atoms and the elemental components are in a gaseous phase (syngas), which will require syngas cleaning prior to use for anything other than combustion. Inert materials are melted and removed as an inert molten slag. Unfortunately, in addition to a high capex, these systems have high operational costs, frequent maintenance requirements, and produce minimal net electric generation.

Oxygen-blown (oxy-fuel) gasification produces a higher quality (Btu/ft³) syngas, glass, or bottom ash/char. The reduced volumes of syngas [no volumes of nitrogen compounds associated with Air-gasification) allow for smaller system components and easier removal and capture of tars and other lesser amounts of syngas impurities. Catalytically enhanced oxy-fuel gasification also greatly simplifies CO₂ capture. One other advantage of catalytically enhanced oxy-fuel gasification is that the production of syngas is potentially more efficient than direct combustion of the original fuel. Syngas can be combusted at higher temperatures [also eliminating the formation of furans or dioxins], so that the thermodynamic upper limit to the efficiency defined by Carnot's rule is higher than predicted or not applicable.

The choice of pyrolysis/gasification process approach depends on the type of feedstock/fuel source, volume of the feedstock available, desired end product(s), market conditions, project economics, facility footprint, logistic capabilities, infrastructure, permitting, location, and a significant number of other factors.

### Gasification Agents

Air—Using air in a gasifier generates a producer gas that is diluted about 50% with nitrogen, resulting larger gas volumes that have an energy content that is only about ⅛^{th} that of natural gas.

Steam—Processes that use large quantities of steam require a great deal of energy in order to drive the reactions, thus reducing thermal efficiency, while potentially greatly increasing the H₂ concentration.

Carbon Dioxide—CO₂ as a gasifying agent increases char conversion but is highly endothermic and the reactions are slower requiring a longer residence time.

Oxygen—Using essentially pure oxygen in a gasifier generates a more concentrated syngas, having a much higher energy content; from 25% to 40% of that of natural gas.

One of the main advantages of oxygen-blown (oxy-fuel) gasification compared to conventional combustion lies within the versatility of applications of the product syngas. The syngas produced by oxygen-blown (oxy-fuel) gasification can be utilized in kilns or furnaces as a substitute for other conventional fossil fuels. The product gas can be used directly in a prime mover, where an unconverted solid fuel could not be used, thereby allowing a higher conversion of fuel energy to electrical energy than could otherwise be achieved by e.g., via combustion to generate steam to power a steam turbine. Finally, it is possible to transform the solid fuel into specific chemical components that can be isolated, e.g., CO and hydrogen, for use as a basis for the synthesis of chemical compounds such as methanol, F-T lubricants, F-T liquids, etc. All of these applications require syngas cleaning beyond the levels needed for combustion. The steps necessary to clean the produced gas are feedstock specific and must meet end use as well as regulatory requirements.

Over the last twenty years, significant advances have been made in the field of gasification of biomass and wastes and the associated gas cleaning systems. Not all of these gas cleaning system innovations are fully developed industrial technologies and they do not work equally well based on variations of feedstocks. This situation is complicated by the fact that many of these pyrolysis/gasification processes themselves are extremely sensitive to feedstock characteristics. Lack of system feedstock flexibility, due to the inability to manage ash, moisture, variable or low heat content, different fuel preparation and handling requirements, and variations in produced gas cleaning requirements/levels due to feedstock chemical properties can be a significant hinderance to any individual pyrolysis/gasification process.

Any gasification system capable of utilizing unsorted MSW (municipal solid waste “trash”) as a fuel source will require a MSW sorting, and separation system to remove approximately 99% of the following materials prior to consumption:
Ferrous Metals
Non-Ferrous Metals
Glass
Stones/Rocks/Brick/Dirt

These materials, if not removed, are highly abrasive to fuel preparation and handling systems, fuel feeding systems, and gasification process equipment. Additionally, they represent mass or volumes with no Btu content and hinder gasification process energy release.

Sorting improves the MSW fuel quality to aid in the gasification process. The sorting steps are inclusive of other measures that may also be needed (depending on the gasification process being utilized):
Screening—removal of dirt
Classification—removal of inert materials (Glass, Metals, Rocks)
   a. Magnetic—ferrous metals
   b. Eddy Current—non-ferrous metals
   c. Air Classification—rocks and glass

The composition of MSW is very inconsistent. The key variables affecting consumption, following the required sorting activities include:
Moisture Content—Variable—typically high
Heat Content—Variable—typically low
Ash Content—Variable—typically high
Chemical Characteristics—Variable [chemical contaminants, heavy metals]

Moisture content can be addressed by a combination of drying and sizing:
Drying—moisture reduction
Sizing—size reduction (includes shredding and grinding)

The ash content and chemical characteristics of the fuel must be dealt with during the gasification process. Catalytically enhanced oxy-fuel gasification addresses these two issues via the use of catalysts addition during the gasification process, coupled with gasifier-controlled temperature, pressure, oxygen feed, and residence time. Ash is converted to a melt (molten glass) that captures much of the chemical contaminants found in MSW in an inert frit (volcanic glass) that is chemically inert and non-leaching. Undesirable contaminants that form “tars” are catalytically destroyed by the use of controlled catalytic volumes of CO₂, high temperature steam, with oxygen, at a required temperature range, low gasifier operating pressure, and high gasifier residence time.

Given that MSW has a much higher and more variable number of potential contaminants, catalytic oxy-fuel gasification has several advantages over traditional combustion:
It requires only a fraction of the stoichiometric amount of oxygen necessary for combustion.
The formation of tars, dioxins, furans, SOₓ, and NOₓ are limited by the use of catalysts and gasifier operating conditions.
The volumes of process gases are lower, requiring smaller and less expensive syngas cleaning equipment.
The lower syngas volumes result in a higher partial pressures of contaminants in the syngas, which favors more complete, particulate capture, acid gas removal, tar removal, and sulfur capture.
Improved syngas quality allows for enhanced hydrogen separation and production.
The ash residue from most MSW gasification processes contains heavy metals, is hazardous and may require post-treatment before it can be sent to a landfill, whereas the catalytic oxy-fuel gasification produces an inert, vitrified, non-leaching glass that is a commercial by-product.
Waste (inert) volumes are reduced compared to incineration.
Catalytic oxy-fuel gasification generates a combustible gas (syngas) that can be integrated with the Fischer-Tropsch processes to produce F-T liquid fuels and products.
Catalytic oxy-fuel gasification syngas, which has been cleaned, when burned via oxy-fuel combustion produces only water vapor and CO₂, simplifying CO₂ capture.
High concentrations of CO₂ exiting the oxy-fuel combustion furnace allows for the Cryogenic Capture of pure CO₂ (at least 99.999) as a liquid.

Environmental pollution stemming from waste-to-energy, municipal solid waste, biomass, alternative fuel, and fossil-fueled power plants is of worldwide concern. Power plants emit air pollutants that may be toxic, e.g., toxic metals and polyaromatic hydrocarbons; precursors to acid rain, e.g., sulfur oxides (SOₓ) such as sulfur dioxide (SO₂), and nitrogen oxides (NOₓ); precursors to ozone such as NO₂ and reactive organic gases; particulate matter; and greenhouse gases, notably CO₂. Power plants also discharge potentially harmful effluents into surface and ground water, and generate considerable amounts of solid wastes, some of which may be hazardous.

Despite certain methods and technologies being developed that reduce emissions and effluents, they are often expensive and require considerable energy. These technologies include NOₓ reduction, particulate capture, sulfur dioxide removal, mercury, and carbon dioxide capture. Additionally, depending on the fuel source, dioxins and furans are emitted. If left untreated, flue gas from power plants, industrial facilities, and other sources can substantially affect local and regional air quality.

Regardless of the fuel source, combustion utilizing air produces large quantities of NO₂, reactive organic gases, and CO₂.

This CO₂ can be “captured” or removed from the flue gas using several known methods including air separation/flue gas recycling, amine scrubbing, cryogenic fractionation, and membrane separation. Among these methods, air separation/flue gas recycling is considered to be the most cost and energy efficient, although amine scrubbing is a close competitor. However, all of these methods significantly impair the efficiency of the power plants in which they are used.

It would be advantageous to have a system, method, or apparatus for oxy-fuel gasification and combustion that overcomes the disadvantages of the prior art. The present disclosure provides such a system, method, or apparatus.

### BRIEF SUMMARY

The present disclosure features the rotary kiln catalytically enhanced oxy-fuel gasification and oxy-fuel combustion system—facility or power plant that captures the CO₂ and emits virtually no pollutants. The plant effectively removes all flue gas constituents and needs no smokestack. This plant can be fueled by municipal solid waste, biomass, alternate wastes, coal, or hydrocarbon fuels. The power plant as envisioned operates as both a baseload electric generating facility and as an “Eco-Refinery.” This unique distinction is due to the ability of the facility to convert waste, alternative or fossil fuels into a combination of commercial by-products, including, but not limited to baseload electricity, hydrogen production and 100% CO₂ capture. The captured CO₂ can be sequestered, e.g., in the deep ocean, or put to practical use, such as for enhanced oil recovery, or as a chemical feedstock.

Thus, in one aspect, the present disclosure is directed to an electric power generating facility, the rotary kiln catalytically enhanced oxy-fuel gasification and oxy-fuel combustion system will be capable of responding to grid/system transient conditions. In addition to baseload electric generation, voltage support via generator design power factor (0.85) or volt-ampere reactive (VAR) support, black start capability, and grid independent operating capability will be available.

In another aspect, the present disclosure is directed to an “Eco-Refinery,” the rotary kiln catalytically enhanced oxy-fuel gasification and oxy-fuel combustion system facility offers a “hub and spoke” capability to expand beyond the capture of 100% of the CO₂, production of distilled water, industrial salts, and volcanic glass; as well as the production options of hydrogen, graphene oxide. The new power plant offers significant advantages: (1) It is environmentally safe as the result of CO₂ capture and zero NOₓ and SOₓ emissions, (2) It is capable of oxy-fuel gasification of practically any available feedstock; and (3) produces by-products in a suitable physical state for easy delivery and commercial use.

In yet another aspect, the present disclosure is directed to a “hub and spoke” design provides points for expansion into numerous commercial by-products and processes.

The “Hub and Spoke” concept allows for the optimization of process(es) and power plant (facility) economics.
Base Design with Multiple Configurations
Multiple Process Integration Opportunities
Multiple Commercial By-Products
The oxy-fuel facility as envisioned, will consist of the following principal components:
Fuel Receiving, Fuel Preparation, Fuel Storage, and Fuel Feeding System.
Oxygen Receiving and Storage System and/or Air Separation Unit with an Oxygen Storage System.
Catalyst Storage and Feeding System.
Rotary Kilns.
Syngas Cleaning System.
Hydrogen Separation and Storage System.
Oxy-fuel Fired Boiler.
Steam Turbine Generator(s).
Feedwater Heaters.
Wet Electrostatic Precipitator.
Flue Gas Chiller(s).
Cryogenic CO2 Capture and Storage System.
Process Water Treatment and Storage System.
Raw Water Distillation and Storage System.
Dry Cooling Tower.
Continuous Emissions Monitoring System.
Black Start Emergency Diesel Generators.
Main Power Step-up Transformers and Auxiliary Transformers.

In general, the disclosure features a new power plant that includes an air separation unit arranged to separate oxygen from air and produce streams of substantially pure liquid oxygen; a oxy-fuel rotary kiln gasifier, a syngas cleanup system; a oxy-fuel fired boiler to combust a fuel, synthesis gas, in the presence of substantially pure oxygen gas to produce an exhaust gas comprising water and carbon dioxide; and a carbon dioxide removal unit arranged to remove water vapor, particulates, and recover carbon dioxide gas from the exhaust gas, recycle a portion of the recovered carbon dioxide gas for use in the rotary kiln gasifier, and liquefy the remainder of the recovered carbon dioxide gas for removal from the plant. In this new plant, the carbon dioxide removal unit is thermally integrated with the air separation unit by directing the stream of liquid oxygen from the air separation unit to the carbon dioxide removal unit to liquefy the remainder of the recovered carbon dioxide gas, the liquid oxygen thereby evaporating and forming cold oxygen gas which is then pre-heated prior to use in the rotary kiln gasifier and oxy-fuel fired boiler.

The air separation unit can also separate nitrogen from the air and produce a stream of cold, substantially pure nitrogen. A portion of the cold nitrogen is directed to cool the air prior to separation of oxygen and nitrogen. The substantially pure nitrogen is at least 95 percent, and preferably at least 97 percent, nitrogen in the form of a liquid.

In the new plant, the “substantially pure” liquid (and gaseous) oxygen is at least 95 percent oxygen, and preferably at least 97.5 percent oxygen, or higher. This level of purity (at least 97.5%) is required to achieve lowest levels of nitrogen compounds in the synthesis gas from the gasifier or in the exhaust gas from the oxy-fuel fired boiler.

In one embodiment of the new power plant, about 95 percent of the carbon dioxide recovered from the exhaust gas, which includes previously recycled carbon dioxide and carbon dioxide newly produced from combustion, is liquefied for removal from the plant, and about 5 percent of the recovered carbon dioxide is recycled for use in the rotary kiln gasifier. When the power plant is operated at a steady state, an amount of carbon dioxide equal to 100 percent of the carbon dioxide produced from combustion is liquefied for removal from the plant.

The air separation unit can include a cooler arranged to cool the air prior to separation of oxygen, a compressor arranged to pressurize the air prior to separation of oxygen, and a distillation tower arranged to separate the oxygen from the air.

The carbon dioxide removal unit can include a compressor arranged to pressurize the remainder of the recovered carbon dioxide gas, chillers arranged to remove water vapor from the remainder of the recovered carbon dioxide gas, a cooler arranged to cool the remainder of the recovered carbon dioxide gas, and a condenser arranged to liquefy the remainder of the recovered carbon dioxide gas using either the liquid oxygen or liquid nitrogen as a cooling source.

In another embodiment, the power plant further includes a compressor arranged to pressurize the liquid oxygen and liquid nitrogen from the distillation column, e.g., to a pressure such as 12 bar, prior to directing the liquid oxygen or liquid nitrogen to the carbon dioxide removal unit to liquefy the remainder of the recovered carbon dioxide gas; and a heat exchanger arranged such that the cold oxygen or nitrogen gas from the air separation unit is used to cool the recovered carbon dioxide gas prior capture and removal from the plant. Preferably, the power plant includes heat exchangers arranged such that both the cold oxygen gas and the cold nitrogen from the air separation unit are used to cool the recovered carbon dioxide gas.

The power plant will include an oxy-fuel fired boiler arranged to produce steam and a flue gas using the syngas from the rotary kiln gasifier as a heat source, and further arranged to preheat the cold oxygen gas produced by liquefaction of the remainder of the recovered carbon dioxide gas.

In another aspect, the disclosure features a new method of generating electricity with virtually zero pollutant emissions in a power plant a conventional steam turbine generator. The actual amount of pollutant emissions depends on the efficacy of the capture mechanisms in the flue gas/CO₂ removal process and the purity of the oxygen produced. Thus, “virtually zero pollutant emissions” as used herein means a level of pollutant emissions limited to essentially fugitive emission around valve packing, flanged areas, and expansion joints.

The new method includes the steps of arranging the oxy-fuel fired boiler to combust a synthesis gas in the presence of substantially pure oxygen gas, and to produce an exhaust gas including water and carbon dioxide; recovering carbon dioxide gas from the exhaust gas; recycling a first portion of the recovered carbon dioxide gas for utilization in the rotary kiln gasifier; separating oxygen from air and producing a stream of substantially pure liquid oxygen and nitrogen; directing the substantially pure liquid oxygen or liquid nitrogen to liquefy a remaining portion of the recovered carbon dioxide gas for removal from the plant, the liquid oxygen thereby evaporating and forming oxygen gas; and directing the oxygen gas to the rotary kiln gasifier and oxy-fuel fired boiler.

The method can include the further steps of separating nitrogen from the air and producing a stream of cold, substantially pure nitrogen; and directing the cold nitrogen to cool and liquify the recovered carbon dioxide gas prior to removal from the plant.

In one embodiment of this method, about 5 percent of the recovered carbon dioxide gas is recycled, and about 95 percent of the recovered carbon dioxide gas is liquefied for removal from the plant. During steady state operation, an amount of carbon dioxide equal to 100 percent of the carbon dioxide gas produced from combustion is liquefied for removal from the plant.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, the preferred methods and materials are described below. All publications, patent applications, patents, and other references mentioned herein are incorporated by reference. In addition, the materials, methods, and examples are illustrative only and not intended to be limiting.

### Rotary Kiln

The selection of the rotary kiln for use in catalytically enhanced oxy-fuel gasification is based on a number of important factors. The rotary kiln itself has the following characteristics:
Considered the most versatile and the most durable of “incineration” systems.
Feedstock versatility—can manage almost any type of waste or fossil fuel.
No internal moving parts.
Maintenance requirements are moderate.
Minimal operating temperature restrictions.
Slightly sub-atmospheric operating pressures.
Designated system for the destruction of hazardous wastes.
Amenable to oxygen-blown (oxy-fuel) operation.
Amenable to slagging operation .
Has a working history as an incinerator, pyrolysis unit, and gasifier.
For oxy-fuel gasification, air in-leakage must be addressed at the rotary kiln seals.

### Rotary Kiln Catalytically Enhanced Oxy-Fuel Gasification Process Considerations

The rotary kiln catalytically enhanced oxy-fuel gasification process is centered on the control of the rotary kiln gasification environment, i.e., oxygen/steam/CO₂/flux (catalysts), fuel feed control and feedstock residence time, operating temperature and pressure, and the prevention of air in-leakage.

Key design and operational areas that are addressed to achieve the optimum gasification environment include:
Sophisticated control system, monitoring instrumentation, and control algorithms.
An inerted, air-locked, dual fuel feed system that prevents air from entering with the fuel.
Rotary kiln enhanced end seals to prevent air in-leakage (infiltration).
The end seal design will prevent the formation of hot spots at the ends of the kiln due to air infiltration. Traditionally, air enters a kiln through the lower end, which tends to increase combustion (increased CO₂) and forms hot spots near the air infiltration point.
The gasification control system will help prevent potential hot spots created by “rich” or highly volatile “slugs” of fuel in the fuel feeding system being fed into the rotary kiln. Highly energetic fuels (usually liquids) may “flash” causing a hot spot or potentially cause “a puff,” an over-pressure condition in the kiln. Both events can be avoided by proper design, operational controls, and control algorithms.
Fuel/oxygen/steam mixing, the rotational mixing pattern of the fuel in the kiln causes some fuel on the bottom of the kiln to be intermittently minimally exposed, thus creating a need for an extended residence time to achieve high carbon conversion levels.
Control of syngas velocity to prevent high syngas particulate (fly ash and tar) loading will be accomplished via the gasification control system.
Slag/melt removal via a sealed water quench system to prevent air infiltration at the slag discharge.
Ash prevention via the gasification control system prevents the occurrence of ashing conditions caused by a combination of oxygen / steam turbulence, high syngas velocities, poor fuel additive (catalyst) control, poor temperature control. Proper operational control of these factors in the kiln keeps the potential for fly-ash formation to a minimum.

The rotary kiln catalytically enhanced oxy-fuel gasifier operation will function to find the right balances to minimize the possibility of too much combustion in the gasifier, optimize the production of a clean high-quality syngas, minimize required operator inputs (via automation), provide for lower maintenance and higher reliability, and to perform predictably.

### Rotary Kiln Advantages:

Can be used for a wide variety of both liquids and solid feedstocks.
Can manage the formation of “melt” slagging.
Provides for good mixing with oxygen/steam/CO₂/flux (catalysts) for solid fuels.
Continuous melt/slag removal does not interfere with gasification.
Rotational speed of the kiln can be varied to help control residence time.
No fuel preheating or mixing required [varies with fuel type(s)].
No bottom ash handling required.

### Rotary Kiln Disadvantages:

High capital cost, but is comparable to other biomass/waste to energy systems.
Requires a source of essentially pure oxygen.
Kiln refractory is subject to damage from erosion (melt), heating and cooling (startup and shutdown), and acidic conditions (melt).
Over-pressure excursions from highly energetic fuels (puffs) could lead to potential atmospheric emissions.
Spherical or cylindrical solid feedstock may pass through the kiln faster and avoid complete gasification (increased LOI (loss of ignition) or (carbon loss)).
Potential air in-leakage around seals can create hot spots and can lower fuel efficiency and syngas quality.
Large kiln surface areas result in lower thermal efficiencies.
Liquid fuels must be able to be atomized.
Liquid fuels should be heated prior to admission to the kiln.
Liquid waste fuels may clog injection nozzles.

Other aspects, embodiments and features of the present disclosure will become apparent from the following detailed description when considered in conjunction with the accompanying figures. In the figures, each identical, or substantially similar component that is illustrated in various figures is represented by a single numeral or notation. For purposes of clarity, not every component is labeled in every figure. Nor is every component of the disclosure shown where illustration is not necessary to allow those of ordinary skill in the art to understand the disclosure.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a block diagram of the rotary kiln catalytically enhanced oxy-fuel gasification and oxy-fuel combustion system.

FIG. 2 is a block diagram of the RK-GEN process low with Hydrogen Capture

FIG. 3 is a schematic of the Rotary Kiln Catalytically Enhanced Oxy-Fuel Gasification and Oxy-fuel Combustion System—Syngas Cleanup System

FIG. 4 is a block diagram of the closely-integrated air separation unit (ASU) system

FIG. 5 is a block diagram of the RK-GEN synthesis gas cleanup process flow

FIG. 6 is a block of the RK-GEN raw municipal solid waste (MSW) receiving, handling, and feeding process flow

FIG. 7 is a block diagram of the Hub and Spoke concept of the “Eco-Refinery.

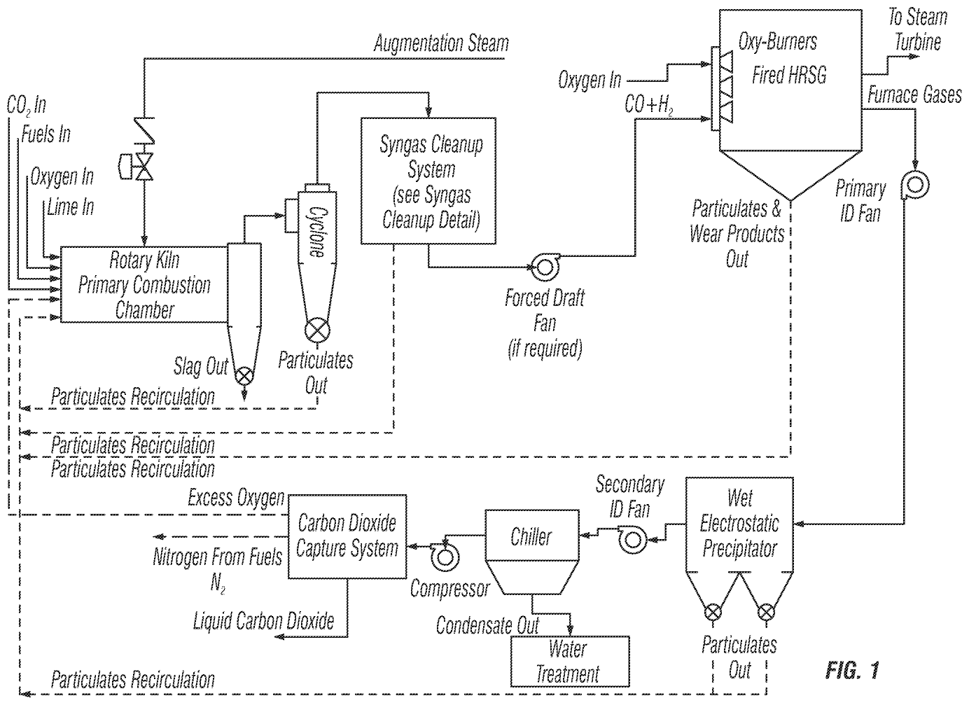

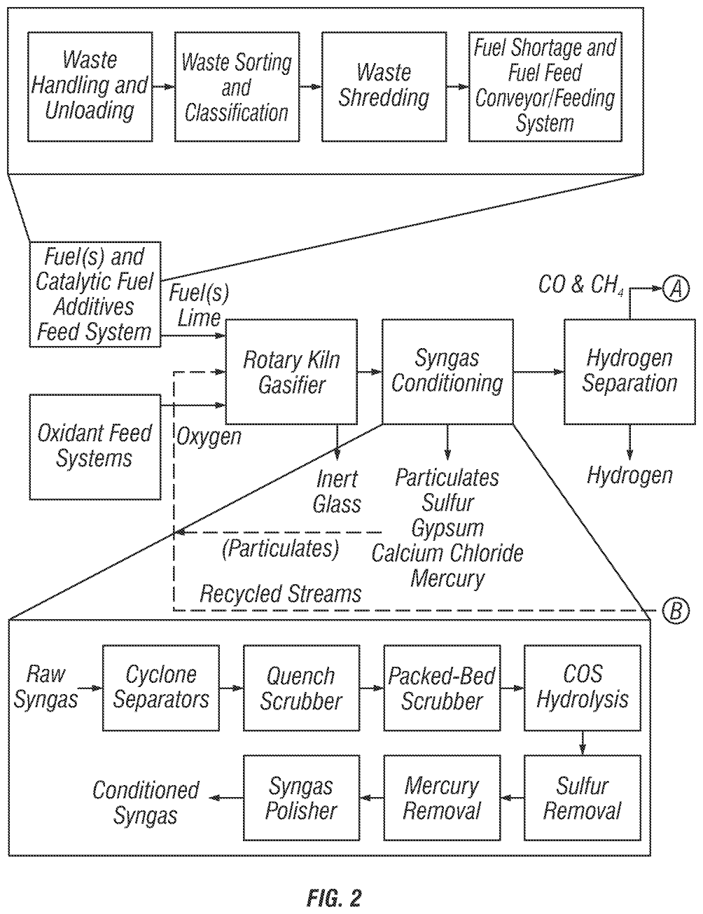

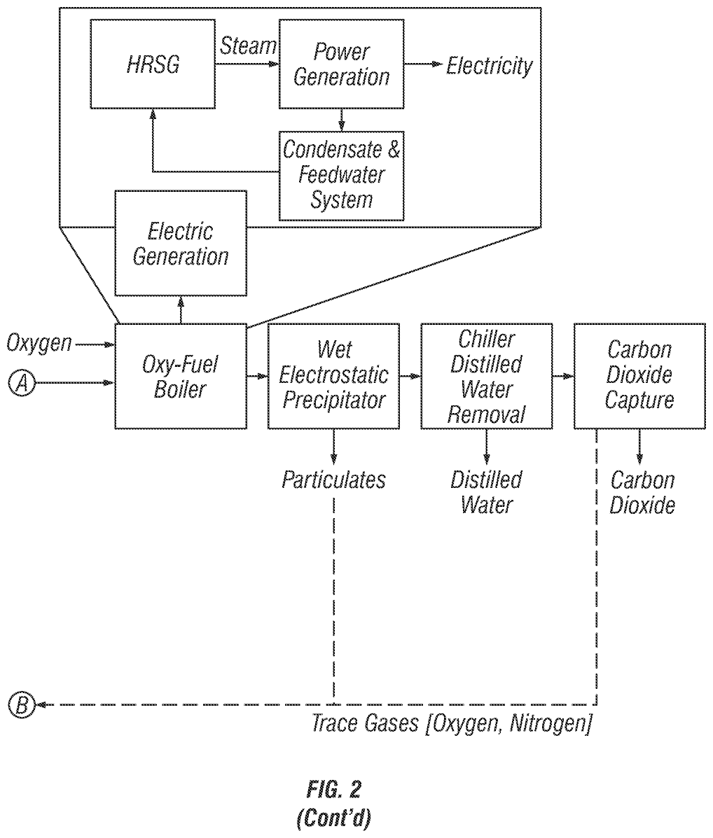

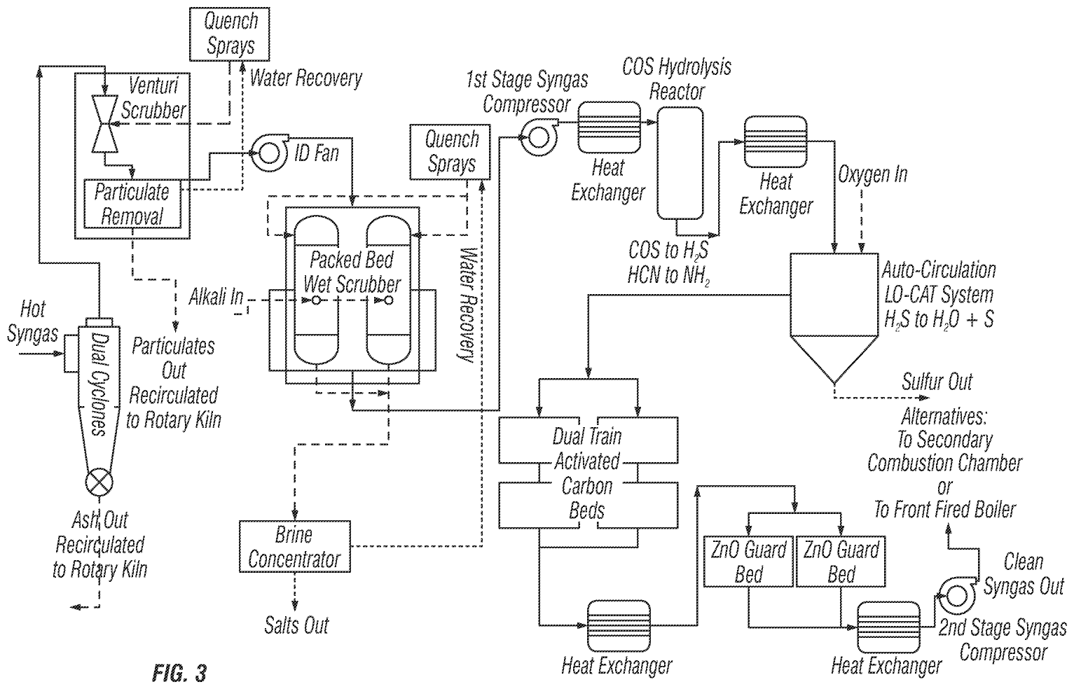

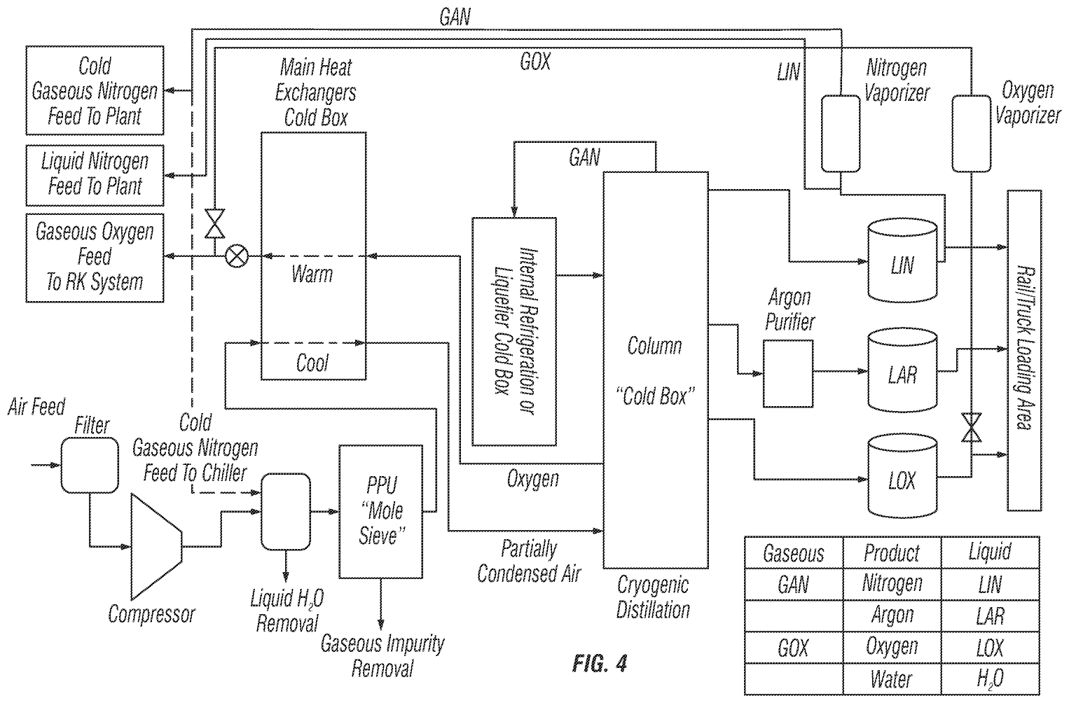

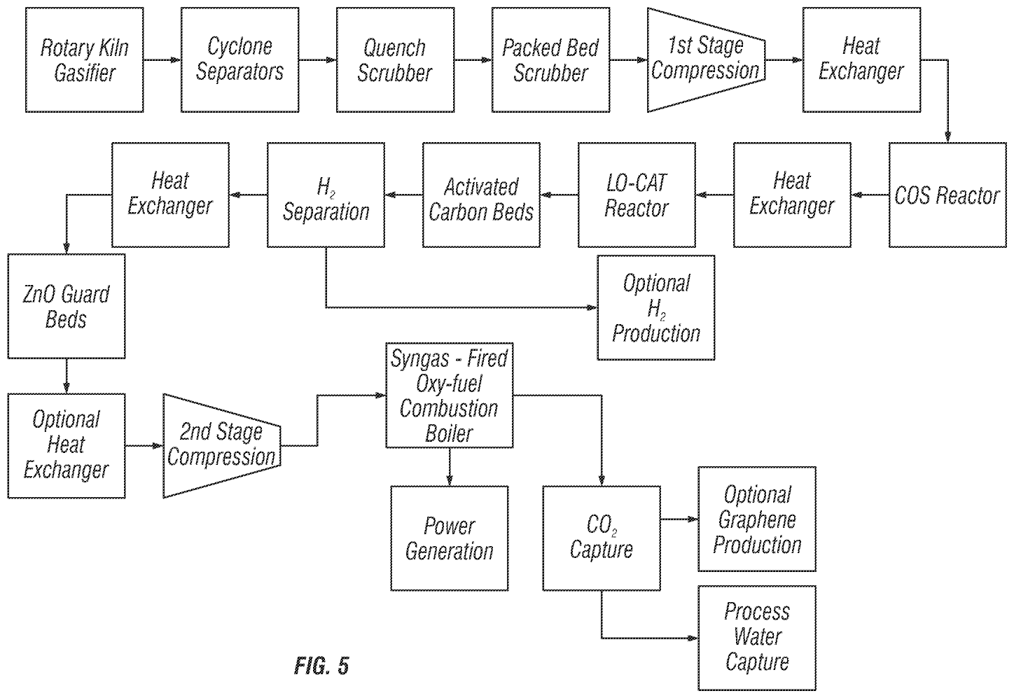

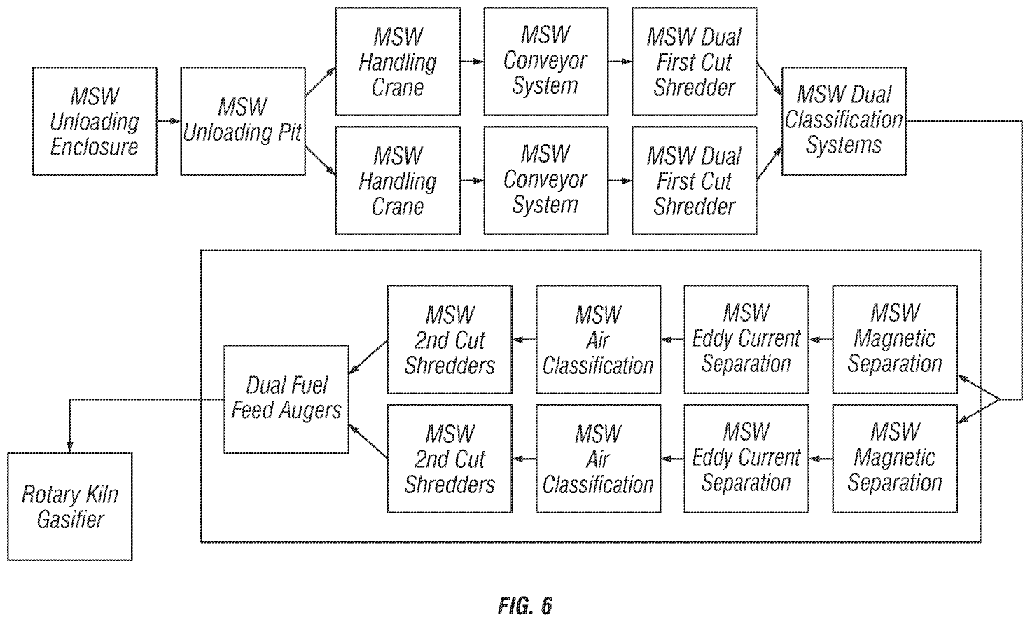

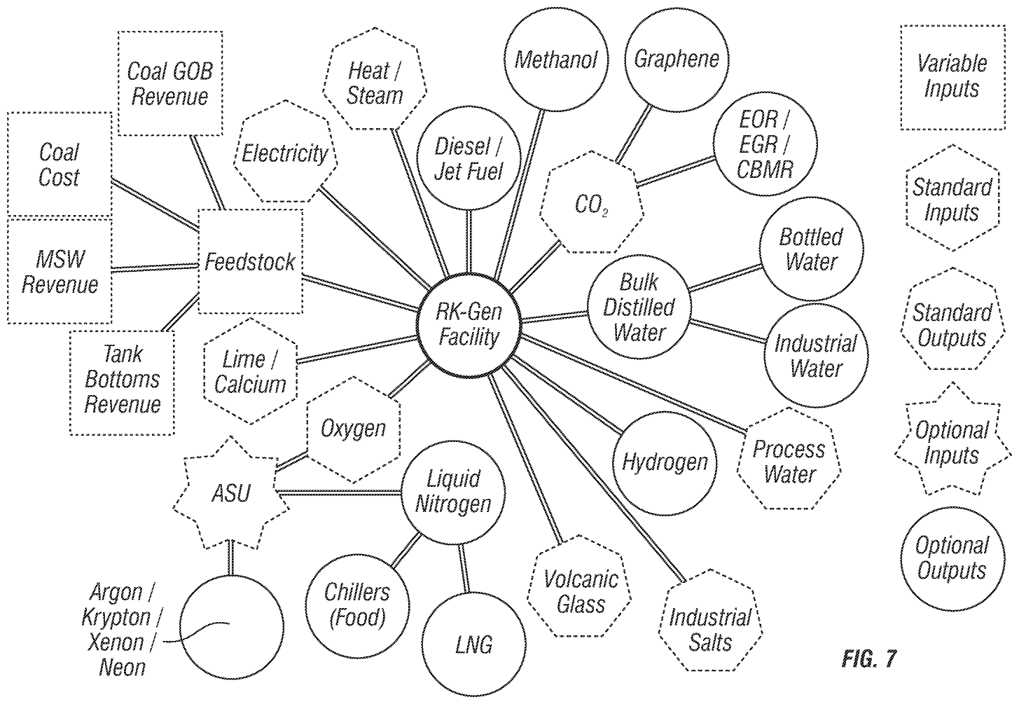

### DETAILED DESCRIPTION

Embodiments of the disclosure will now be described.

The disclosure introduces novel approaches and enhancements, and an integrated design to known state-of-the-art components. Four new aspects have been developed. The first is an enhanced rotary kiln gasification process to produce a synthesis gas, and the second is an integrated Air Separation Unit and CO₂ Capture System. The second is the rigorous synthesis gas (syngas) cleanup system that allows for simplified hydrogen capture. The third is the combination of oxy-fuel gasification with oxy-fuel combustion in a two-step approach to energy conversion. The fourth is the use of cryogenic capture to efficiently remove CO₂ from the flue gas stream without the release of other atmospheric emissions. The combination of these four approaches utilizing off-the-shelf technologies to achieve 100% CO₂ capture, green hydrogen production, multiple by-product output options, along with no hazardous waste streams and no atmospheric pollutant emissions, and omnivorous fuel consumption capabilities are the significant achievements of this novel approach to energy production.

The improved rotary kiln catalytically enhanced oxy-fuel gasification and oxy-fuel combustion system—power plant combines several basic principles with new techniques. One principle used in the power plant is the gasification of the feedstock with a combination of catalysts; essentially pure oxygen, high temperature steam, high temperature carbon dioxide and lime catalyst additives. Then following synthesis gas cleanup and optional hydrogen separation, combusting the synthesis gas in essentially pure oxygen instead of air. The combustion of the synthesis gas in pure O₂ produces an exhaust or flue gas consisting of only H₂O and CO₂ with limited possible minor dissociation products, depending on the final purity of the synthesis gas following syngas cleanup. Since H₂O is readily condensable (and reusable), the sole major combustion product is CO₂; the efficient capture thereof is the major purpose of the new plant design.

Feedstocks (fuel) is received and prepared for feeding into the rotary kiln(s). The prepared fuel is blended with the lime catalyst at prescribed rates and inerted to prevent the possibility of spontaneous combustion using CO₂ and then is fed via air-lock feeders into the rotary kiln(s). Simultaneously, pre-heated oxygen, high temperature steam, and pre-heated CO₂ are injected into the rotary kiln(s) at individually prescribed rates to establish the proper gasification environment. Pressure in the rotary kiln(s) are maintained at slightly sub-atmospheric levels and oxygen levels are maintained at sub-stoichiometric levels. The rotation of rotary kiln(s) provides for mixing of the fuels, catalysts, and gases to achieve high carbon conversion and feedstock reactivity rates.

In the rotary kiln enhanced control of catalytic processes within the rotary kiln operating environment ensures high carbon conversion and a significant reduction in synthesis gas contaminants. Ash in the feedstock, along with a significant portion of the heavy metals and other inert contaminants are captured by the slagging environment maintained within the rotary kiln(s) and are removed as melt (liquid glass). The melt is solidified in a sealed water bath to form a volcanic glass or frit, which is a non-leaching, inert material. The capture of a significant portion of the heavy metals and other contaminants in an inert melt (volcanic glass) reduces down stream syngas cleanup requirements and eliminates the production of a “bottom ash” or hazardous residue.

Induced draft fans pull the syngas generated from the rotary kiln(s) into the syngas cleaning system for removal of contaminants and to prepare the syngas for optional hydrogen separation. In the syngas cleanup system, the syngas leaving the gasifier requires additional levels of cleanup in order to meet specific requirements for downstream processes. This includes removal of particulate matter, sulfur compounds, chlorine compounds, nitrogen compounds, unreacted hydrocarbons (tars), and heavy metals compounds. These contaminants can plug up valves and operating systems, cause corrosion, poison downstream catalysts, or prevent the plant from complying with environmental permits. Syngas cleanup can also be used to selectively remove and concentrate specific gases, such as to allow for enhanced hydrogen separation and capture and supports carbon dioxide (CO₂) capture and removal for compression and transportation by pipeline for either permanent underground storage or for use in enhanced oil recovery. The remaining cleaned syngas is pressurized and directed to an oxy-fuel boiler for oxy-fuel combustion with essentially pure oxygen.

In the oxy-fuel boiler, heat is generated by the combustion of essentially pure oxygen with the cleaned synthesis gas to produce heat, water vapor and CO₂. The combustion energy release is transferred to the water wall, superheat, reheater, and economizer sections of the boiler to produce steam to drive a steam turbine generator to produce electricity. Flue gas from the oxy-fuel boiler is directed via induced draft fans to a wet electrostatic precipitator for trace particulate removal. Chillers then lower the flue gas temperatures further to the condensation point of the water vapor to achieve process water capture and any remaining particulates are removed. The essentially dry pure CO₂ flue gas stream is then pressurized and undergoes cryogenic liquid CO₂ capture. Trace amounts of oxygen and any nitrogen are recirculated to the rotary kiln.

Liquid oxygen from storage or liquid nitrogen in the case of an Air Separation Unit (ASU) being utilized are used to cool the process water chillers and the CO₂ cryogenic liquid capture unit. The thermal integration of the liquid oxygen preheating/liquid nitrogen preheating with the CO₂ cryogenic unit significantly reduces the power consumption of CO₂ capture.

### Feedstock Gasification—Tar Production

Raw biomass (somewhat feedstock dependent) gasification product syngas includes varying levels of particulate matter, ammonia, sulfur compounds, hydrochloric acid, and alkali metal species as impurities. Sorted MSW may contain up to 70%-80% biomass. Gasification of both biomass (various feedstocks) and MSW are also subject to the production of tars. Tar formation remains the main bottleneck for biomass gasification technologies and is the leading obstacle impeding the development of improved gasification processes. Tar formation is problematic and must be addressed. Tars tend to form sticky deposits in locations that can significantly impair equipment performance and are difficult to remove. Gasified biomass tars have a number of undesirable characteristics:
Consist of unwanted hydrocarbon & non-hydrocarbon compounds.
Reduce gasification conversion efficiency.
Decrease the quality of syngas.
Increase the cost of syngas cleanup processes.
Can lead to deposition of tars on downstream equipment and create fouling.
Can interfere with downstream production and processes.

Tars consist of various molecules of carbon, hydrogen and oxygen or nitrogen. Tars are formed at various temperatures starting at 450° F. up to 1800° F. and can be classified as Primary and Secondary tars.
Primary tars begin forming at approximately 450° F. and have been broken down and destroyed by the time the temperature reaches 1500° F. (815° C.).
Secondary tars begin forming at approximately 900° F. and have been broken down and destroyed by the time the temperature reaches 1800° F.

There are four (4) major product classes of tars that result during the gasification phase thermal cracking/gasification of fuel sources.
Primary Tars—Cellulose-derived Products
Secondary Tars—Phenolics and Olefins
Alkyl Tertiary Tars—Methyl Derivatives of Aromatic Compounds (methylnaphthalene, toluene, indene, etc.)
Condensed Tertiary Tars—Polynuclear Aromatic Hydrocarbons (PAH) (benzene, naphthalene, pyrene, etc.)

In the rotary kiln catalytically enhanced oxy-fuel gasification process tar destruction is accomplished by the combination of seven (7) controlled gasifier process conditions:
Thermal—operating temperature range
Pressure—low operating pressure
Residence Time—feedstock gasification exposure time
Partial Oxidation—essentially pure oxygen feed
Steam—recirculated high temperature steam
CO₂—recirculated high temperature carbon dioxide
Fuel Catalysts—addition of lime, dolomite, calcium carbonate

These tar destruction process conditions also destroy other unwanted oxygenates that may occur as a function of fuel source(s). The controlled combination of catalysts used, breaks the “tars” down into Carbon Monoxide and Hydrogen. They also help to neutralize the presence of organic acids that contain chlorine to assist in the formation of low-melting point eutectics (reducing the melting point of silicates in the ash).

While controlled gasifier process conditions as described reduce tar production and destruction, there is a practical limit to the ability of any gasification system to completely remove all tars formed within the syngas. Additional syngas cleanup steps are required if high quality syngas is needed to be utilized for any purpose other than oxy-fuel combustion.

Syngas from the rotary kiln catalytically enhanced oxy-fuel gasification process will contain some limited levels of tars despite the destruction of tars as previously described. These tars will range typically from 2.5 microns to sub-micron in size. Syngas cleanup tar removal processes can include:
Thermal tar removal processes
Catalytic tar cracking
Physical tar removal systems
   a. Quench and packed bed scrubbers
   b. Oil bath scrubbers
   c. Wet electrostatic precipitators
Activated carbon beds
Zinc Oxide guard beds

In the rotary kiln catalytically enhanced oxy-fuel gasification process/syngas cleanup system, tars are minimized via destruction and the remaining tar removal is accomplished via a multi-step process to condense, scrub, and capture the remaining tar compounds.
Cyclone separation
Wet venturi quench scrubbers
Wet packed-bed scrubbers
Activated carbon bed filters
Zinc Oxide (ZnO) guard beds

### Feedstock Gasification—Particulate Production

Particulate matter (PM) in the syngas stream is typically made up of ash, unreacted carbon char, and condensed chlorine and alkali compounds. The need for PM removal depends primarily on the downstream use of the syngas. For use in direct firing (boilers, HRSGs, thermal oxidizers, etc.), PM can be tolerated and is typically restricted by emissions limits (i.e., the effect on the exhaust gases emanating from the burner). The PM limits are progressively more stringent when the syngas is used for downstream conversion processes, enhanced hydrogen separation, or for use in reciprocating engines and gas turbines. PM can be removed using various dry or wet PM removal systems.

Syngas particulate removal processes include:
Cyclones and rotating particle separators [2.5 μm and larger]
Water quench systems [1 μm and larger]
Candle filters (ceramic or sintered metal) [0.05 μm and larger]
Packed bed scrubbers [2.5 μm and larger]
Electrostatic precipitators (wet or dry) [0.1 μm and larger]

In the rotary kiln catalytically enhanced oxy-fuel gasification process/syngas cleanup system, particulate removal is accomplished via the following three steps:
Cyclones separators [2.5 μm and larger]
Venturi water quench systems [1 μm and larger]
Packed bed scrubbers [2.5 μm and larger]

### Feedstock Gasification—Acid Gas and Chlorine Compounds/Halides Production

All gasification processes require a syngas—acid gas cleanup step, regardless of the feedstock used or the ultimate use of the synthesis gas produced. Acid gases include varying levels of HCl, HF, H₂S, CO₂, HCN, NH₃ and organic sulfur compound such as COS, CS₂, and mercaptans. These contaminants can poison downstream processes (catalysts) and can cause corrosion damage to components.

Halide species are one of the most abundant and damaging impurities in syngas derived from coal, MSW, RDF and other feedstocks. Halides can cause irreversible damage to downstream processes such as particulate filters, catalysts, gas separation membranes, etc. Halides are binary compounds, consisting of a halogen atom and an element or radical, to make a fluoride, chloride, bromide, iodide, or astatide compound. Many salt compounds are halides including:
Sodium chloride (NaCl)
Potassium chloride (KCl)
Potassium iodide (KI)
Lithium chloride (LiCl)
Copper(II) chloride (CuCl₂)
Silver chloride (AgCl)
Calcium chloride (CaCl₂)
Chlorine fluoride (ClF)
Bromomethane (CH₃Br)
Iodoform (CHI₃)

As previously mentioned, the controlled combination of catalysts used in the rotary kiln catalytically enhanced oxy-fuel gasification process help to neutralize the presence of organic acids that contain chlorine to assist in the formation of low-melting point eutectics (reducing the melting point of silicates in the ash). Despite these neutralization effects, the syngas from the rotary kiln will contain some levels of acid gases and halides.

All commercial acid gas/halide removal is conducted via cold (wet) systems. The principal acid gas removal processes include:
Partial removal in wet venturi quench scrubbers via the use of calcium hydroxide/sodium hydroxide in the scrubbing sprays.
Partial removal in wet packed-bed scrubbers by the addition of calcium hydroxide/sodium hydroxide in the spray media.
Wet electrostatic precipitators (not recommended for hydrogen-rich syngas environments)
Activated carbon bed filters (recommended as syngas polishers and for light acid gas loading)
Zinc Oxide (ZnO) guard beds (recommended as syngas polishers and for light acid gas loading)

The wet acid gas scrubber system is custom designed for the specific application to provide extremely high removal efficiencies in the range of 95% to 99%. These scrubbers operate with a low pressure drop and at low syngas temperatures. The utilization of a combination of acid gas removal processes (wet venturi quench scrubber and packed bed scrubbers) coupled with the use of calcium hydroxide (CaOH), as a neutralizing agent in these processes, will convert the acid gases into salt compounds that are captured as commercial by-products. Remaining limited amounts of acid gases present in the syngas will be removed by the sulfur removal process.

Halide removal is best performed immediately preceding sulfur removal due fouling/poisoning of the regenerable desulfurization sorbents by the various halide species.

Special case, halide contaminants containing metals (i.e., nickel or iron) are not typical, but may also exist in syngas produced from biomass gasification. If present, these impurities can be removed by wet scrubbing or purification by hydrogenation and ZnO absorption.

In the rotary kiln catalytically enhanced oxy-fuel gasification process/syngas cleanup system, acid gas and chlorine compounds/halides removal is accomplished via the following steps:
Wet venturi quench scrubbers
Wet packed-bed scrubbers
Activated carbon bed filters
Zinc Oxide (ZnO) guard beds

### Feedstock Gasification—Alkaline Metals/Alkali Compounds Production

Biomass gasification produces significant amounts of alkali compounds (alkalis), compounds of lead, cadmium, calcium, potassium, magnesium, sodium, silica, and sulfur (CaO, K₂O, P₂O₅, MgO, Na₂O, SiO₂, SO₃) present in the biomass. These alkali compounds vaporize at temperatures above 700° C. during gasification.

Most of these alkali metal compounds will condense at temperatures below about 650° C. (1200° F.) to form particles (<5 μm) in the downstream syngas flow (most probably while in the syngas cleaning system cyclone separators). These alkaline particulates tend to stick to the metal surfaces and can result in corrosion, fouling of heat transfer surfaces, slag formations, and the formation of agglomerates.

As previously mentioned, the controlled combination of catalysts used in the rotary kiln catalytically enhanced oxy-fuel gasification process helps to assist in the formation of low-melting point eutectics (reducing the melting point of silicates in the ash). However, alkali contaminants remaining in the syngas, are primarily removed by a combination of the cyclone separators, wet venturi quench scrubbers and the wet packed bed scrubber.

Alkali contaminants are easily removed by wet scrubbing, making that the preferred method for alkali removal. As the syngas stream temperatures fall below alkali condensation points, alkali vapors will nucleate and agglomerate to form particulate matter in the syngas stream, which can be removed along with other particulates. Particulates removed by the cyclone separators and wet venturi quench scrubbers are recirculated back to the rotary kiln for capture in the melt.

In the rotary kiln catalytically enhanced oxy-fuel gasification process/syngas cleanup system, alkaline metals/alkali compounds removal is accomplished via the following steps:
Cyclone separators
Wet venturi quench scrubbers
Wet packed-bed scrubbers

### Feedstock Gasification—Dioxins and Furans Production

The operating conditions within the rotary kiln catalytically enhanced oxy-fuel gasification process do not provide the environment needed for dioxins and furans to form or reform. Dioxins and furans (toxins) need sufficient oxygen to form or re-form, which the oxygen-deficient atmosphere in the catalytically enhanced oxy-fuel gasifier does not provide. Additionally, the syngas leaving the gasifier is quickly quenched in the acid gas scrubber system, so that there is not sufficient residence time in the temperature range where dioxins or furans could re-form.

### Feedstock Gasification—Sulfur Compounds Production

Regardless of the feedstock, essentially all of the sulfur in the gasifier feedstock is converted to H₂S. The amount of H₂S produced is dependent on the sulfur content of the feedstock.

Sulfur is found in varying levels in biomass, MSW and coal, as well as in other waste feedstocks. Gasification of these feedstocks occurs in a reducing atmosphere (sub-stoichiometric oxygen levels) that forms sulfur compounds in the form of hydrogen sulfide, carbon disulfide, or carbonyl sulfide (H₂S, CS₂ and COS respectively), and rarely in the form of sulfur dioxide (SO₂).

Fortunately, most biomass contains little sulfur (<0.5%), which, during gasification, is converted primarily to H₂S and to a limited degree, COS.

MSW contains varying levels of sulfur. In addition to limited amounts of the sulfur compounds being captured in the rotary kiln catalytically enhanced oxy-fuel gasification process, the syngas leaving the gasifier typically requires additional sulfur contaminant removal. This removal process is referred to as the Acid Gas Removal. The removal of sulfur is desired in order to meet environmental permits limits when the syngas is combusted, as well as when the syngas must be purified for downstream systems that include sensitive catalysts.

Since the total sulfur contained in most raw waste-to-energy syngas streams is small, a combination of acid gas removal processes (wet venturi quench scrubber and packed bed scrubber) will lower the H₂S content of the syngas to less than 4 ppm, which means that all remaining ELS produced in the gasifier must be processed in the sulfur recovery system.

The removal of organic sulfur compounds (COS and CS₂) from the syngas stream can be accomplished by a hydrolysis unit upstream of the sulfur recovery system. The hydrolysis unit converts any COS and CS₂ into H₂S. H₂S can be removed by either an amine or common iron-chelate process, depending on the volume of sulfur present and the volume of the syngas to be cleaned.

A LO-CAT® process (iron-chelate process) located downstream of the hydrolysis unit will remove sulfur from the syngas. The LO-CAT® Process is a cost-effective recovery process for removal of sulfur from syngas in small waste gasification applications producing less than 20 tons of sulfur per day. The LO-CAT® process is greater than 99.9% effective at sulfur removal. The limited amounts of remaining sulfur in the syngas stream will be captured by dual sulfur-impregnated activated carbon beds and dual Zinc Oxide guard beds.

In the rotary kiln catalytically enhanced oxy-fuel gasification process/syngas cleanup system, sulfur compounds removal is accomplished via the following steps:

COS hydrolysis unit
LO-CAT process
Activated carbon bed filters
Zinc Oxide (ZnO) guard beds

### Feedstock Gasification—Mercury Compounds Production

MSW nominally contains higher mercury levels than coal. Combustion of MSW will release a combination of mercuric compounds, mercuric oxides, and elemental mercury into the environment. Elemental mercury is extremely difficult to capture. The removal of mercury is often required in order to meet environmental permits limits when the syngas is combusted, as well as when the syngas must be purified for downstream systems that include sensitive catalysts.

During gasification, mercury contaminants found in the feedstock can readily combine with chlorine, sulfur, and other elements. The standard for mercury removal from syngas is the use of sulfur-impregnated activated carbon. This technology has been proven in a wide range of industrial/commercial gasifier syngas streams. Mercury removal typically occurs after PM, tar removal, acid gas neutralization and removal, sulfur removal and prior to CO₂ removal.

In the rotary kiln catalytically enhanced oxy-fuel gasification process/syngas cleanup system, mercury removal is accomplished in several steps:
A limited amount of mercury compounds will be captured the melt within the rotary kiln
Some of the mercuric salts and oxides will be captured by the acid gas removal system
The bulk of the mercury will be captured by dual sulfur-impregnated activated carbon beds
Following oxy-fuel combustion in the furnace, the wet-electrostatic precipitator will remove any remaining charged particulates containing mercury
Any remaining elemental mercury is captured during the cryogenic capture of CO₂

### Feedstock Gasification—Nitrogen Compounds Production

When gasified, the nitrogen content of most biomass feedstocks results in the production of ammonia (NH₃) 60% to 65% and molecular nitrogen (N₂) 35% to 40%. A limited amount of nitrogen will form hydrogen cyanide (HCN), though this is typically in low concentrations. Formation of HCN is not favored with gasification temperatures below 900° C. and with syngas residence times greater than 2 seconds (8-10 seconds at 800° C. in the rotary kiln). The formation of nitrogen oxide compounds (NOₓ) does not occur at temperatures below 1,000° C. As a result, NOₓ is not found in the syngas exiting the rotary kiln due to the formation temperatures of NOₓ being higher than the gasifier operating temperatures and the reducing conditions present in the gasifier.

The addition of lime or calcined dolomite as a catalyst increases the decomposition rates of ammonia in the rotary kiln gasifier. As a result, the volumes of nitrogen compounds formed from biomass in the rotary kiln catalytically enhanced oxy-fuel gasification process should be extremely low (˜20 ppmᵥ), and as such does not present an undo concern during syngas cleanup.

Concentrations of HCN and NOₓ are expected to be in the extremely low ppm range in the raw syngas leaving the rotary kiln. Trace amounts of HCN are converted to carbon monoxide (CO) and ammonia (NH₃) in the COS hydrolysis reactor used to convert Carbonyl Sulfide (COS) to hydrogen sulfide (H₂S) for removal in the LO-CAT sulfur removal system.

Small amounts of ammonia produced in the COS hydrolysis reactor will either react with trace amounts of NOₓ compounds in the syngas to form Nitrogen and water vapor or will be removed in a sour water stream from the LO-CAT System and treated by the facility process water treatment system. Any remaining trace amounts of NH₃ remaining will be removed by activated carbon bed filtration.

In the rotary kiln catalytically enhanced oxy-fuel gasification process/syngas cleanup system, nitrogen compound removal is accomplished in several steps:
Rotary kiln gasification catalyst addition
COS hydrolysis unit
LO-CAT process
Activated carbon bed filters

### Feedstock Gasification—Syngas CO₂ Production

Carbon dioxide production during gasification is undesirable, as it represents a loss of carbon for process use. Notional values for the composition of syngas (based on feedstock) will vary, but the typical range of CO₂ in syngas percentage is between 4.5% (coal) and 6.0% (biomass). In the rotary kiln catalytically enhanced oxy-fuel gasification process, carbon dioxide production will occur as the result of excess oxygen addition or imbalances in the gasification control algorithms as the result of non-homogeneous feedstocks. Expected syngas CO₂ levels from the rotary kiln are targeted to be approximately 2%-4%.

In combination with water, carbon dioxide is highly corrosive can damage downstream equipment. As previously described, wet acid gas removal systems are effective at removing the CO₂ from the syngas via:
Partial removal in wet venturi quench scrubbers via the use of calcium hydroxide/sodium hydroxide in the scrubbing sprays.
Partial removal in wet packed-bed scrubbers by the addition of calcium hydroxide/sodium hydroxide in the spray media.
Activated carbon bed filters (recommended as syngas polishers and for light acid gas loading)
Zinc Oxide (ZnO) guard beds (recommended as syngas polishers and for light acid gas loading)

The wet acid gas scrubber system is custom designed for the specific application to provide extremely high removal efficiencies in the range of 95% to 99%. The utilization of a combination of acid gas removal processes (wet venturi quench scrubber and packed bed scrubbers) coupled with the preferred use of calcium hydroxide (CaOH), as a neutralizing agent in these processes, will convert the acid gases, along with the CO₂ into salt compounds that are captured as commercial by-products. Remaining limited amounts of acid gases present in the syngas will be removed by the activated carbon and ZnO filters.

In the rotary kiln catalytically enhanced oxy-fuel gasification process/syngas cleanup system, the limited amounts of CO₂ (2%-4%) produced during the gasification process are removed in several steps:
Wet venturi quench scrubbers
Wet packed-bed scrubbers
Activated carbon bed filters
Zinc Oxide (ZnO) guard beds
   Enhanced Hydrogen Capture from Syngas

Tars (hydrocarbon compounds), sulfur compounds, and other syngas contaminants could be problematic as a result of plugging or poisoning of hydrogen separation processes. By utilizing cleaned syngas consisting of CO, H₂, 2-4% CH₄, 2-4% H₂O that has been compressed to 100-150 psig, prior to being directed into the oxy-fuel boiler, potential poisoning of the media in an enhanced separation process for hydrogen capture is minimized. Hydrogen separation from a mixed gas stream by pressure swing adsorption, amine absorption, and cryogenic distillation are expensive processes that are mature technologies, however these methods face environmental challenges, are mostly expensive and require high energy loadings to run efficiently.

For these reasons, membrane separation is desired to overcome the disadvantages of these traditional methods of hydrogen production. Enhanced hydrogen separation and capture from the cleaned syngas is not anticipated to be 100% of the hydrogen in the syngas stream. Separation over a range of 50-80% of the hydrogen present in the syngas is desirable. High purity hydrogen (up to 99.5%) can be separated from the significantly pure syngas by multi-stage membrane separation.

Membrane separation processes are attractive alternatives to the other technologies. Membranes act to provide a physical barrier between the different constituents in the syngas. Membranes have a better capability to treat a wider range of hydrogen in the syngas from 30 to 90 mol %. Membrane separation processes provide the highest operational reliability in situations where system operating conditions become unstable, primarily due to the membrane process not having any mechanical parts. In the event of a change in the syngas feed pressure, the product purity in the membrane system may vary by 10%, while PSA and cryogenic processes can be affected by 30% and 50% respectively.

Numerous categories of membranes are available for hydrogen separation from hydrogen-rich mixtures. These membranes fall into the following categories:
Metallic membranes
Polymeric
   a. Polymer membranes
   b. Polyimide membranes
Inorganic
   a. Carbon molecular sieves
   b. Ceramic membranes
   c. Zeolite membranes

### Metallic Membranes

High purity hydrogen can be separated via dense metallic membranes that are highly selective to hydrogen (usually palladium and palladium alloys). Metal alloys or composite metal membranes have been used for hydrogen purification; however, metallic membranes are sensitive to some gases, such as the carbon monoxide, and other potential poison concentrations for the proposed application. Unfortunately, in addition to excessive costs and potentially short membrane life, the flux in palladium membranes is proportional to the square root of the pressure across the membrane.

### Inorganic Membranes

Inorganic membranes are good alternatives. They have better chemical stability with lower fabrication cost but require higher operating temperatures of 200° C. to 900° C. to operate efficiently.

Carbon molecular sieve (CMS) membranes are rigid pore structures having the advantages of strong mechanical and chemical stabilities and are considered viable for the both high-temperature and high-pressure applications.

Ceramic membranes are inert to poisonous gases and the flux is directly proportional to the pressure across the membranes, but selectivity of hydrogen is more limited due to pore sizing limitations.

Inorganic microporous membranes (such as polycrystalline zeolite membranes) offer many advantages. The flux is directly proportional to the pressure and the stabilized silicas membrane is selective to H₂ molecules, providing high permeation in high-temperature applications. These silica-based membranes are the most commonly applied materials for the separation of hydrogen.

Zeolites membranes are porous crystalline aluminosilicate minerals having pores close to the kinetic diameter of the gases, enabling the separation of components by both molecular sieve properties and the difference in adsorption affinity. Zeolite membranes are regenerable and have high thermal and chemical stability making them suitable candidates for applications involving extreme conditions (e.g., chemically harsh feed streams with high temperatures).

All inorganic membranes have one or more weaknesses:
Inorganic membranes of microporous characteristic such as carbon molecular sieve, silica and zeolite membranes are sensitive to water vapor in the syngas which could cause a substantial drop of membrane performance.
Fabrication of inorganic membranes with high surface areas for the purpose of larger-scale implementation is difficult.

### Polymeric Membranes

In polymeric membranes, the gas molecules are transported through the spaces of the polymer chain network. Hydrogen molecules, which are small, permeate through the polymer membrane more easily than other gases. Unfortunately, selectivity of the membranes do not result in the highest purity hydrogen separation.

H₂-selective polymeric membranes made of glassy polymers have the capability to tolerate high-temperatures (above 100° C.). Unfortunately, there are both selectivity and H₂ permeability issues associated with membrane fabrication that limits the performance of polymeric membranes. To enhance the H₂ selectivity of polymer membranes, metal must be added to modify the surface of the polymers and amine groups are added to the membrane to increase affinity toward CO₂ gas and prevent the diffusion of CO₂ molecules

Polyimide membranes are commercialized membranes for separating hydrogen gas at operating temperatures less than 200° C.

Hydrogen separation as currently envisioned in the rotary kiln catalytically enhanced oxy-fuel gasification process/syngas cleanup system, will incorporate the MTR VaporSep-H₂™ membrane process. This is a synthetic polymer membrane for separating H₂ from syngas to adjust the H₂:CO ratio. Hydrogen preferentially permeates through the membrane, producing a purified hydrogen “permeate” stream and a hydrogen-depleted “ratio-adjusted syngas” stream. The system can accommodate a syngas feed with concentrations of 30-95 mol % of hydrogen. This process is efficient for syngas hydrogen recovery and produces a hydrogen product at 85 to 95 vol % purity. The operating pressure range can accommodate pressures as high as 170 bar, and can operate at less than 100° C. The membrane operating lifetime, with proper operation and maintenance, is nominally 5 years, but can extend up to 7-10 years.

Other advantages of this system include easy installation, simple operation, high reliability, and operational conditions flexibility with a turndown ratio to 20%. The system is compact, and skid mounted for minimal interface requirements. The process requires no chemicals, contains no moving parts, and has minimal utility requirements: low pressure steam, instrument air, and instrument power.

### Oxy-Fuel Combustion

The rotary kiln catalytically enhanced oxy-fuel gasification and oxy-fuel combustion system combines several basic principles with new techniques. One principle used in the power plant is the firing of the fuel in pure or highly enriched oxygen instead of air. The combustion of a cleaned (polished) synthesis gas in essentially pure oxygen produces an exhaust or flue gas consisting of principally H₂O and CO₂ with possible minor dissociation products, depending on the combustion temperature and pressure. Since H₂O is readily condensable (and reusable), the sole major combustion product is CO₂; the efficient capture thereof is a major purpose of this new plant design.

In the rotary kiln catalytically enhanced oxy-fuel gasification and oxy-fuel combustion system, the cleaned syngas consisting of CO, H₂, 2-4% CH₄, 2-4% H₂O is compressed to 100-150 psig and directed into an oxy-fuel boiler. The syngas is combusted with pure oxygen (6%-8% super stoichiometric) at high temperatures to produce a flue gas principally consisting of H₂O and CO₂. Due to the purity of the syngas being combusted and the lack of nitrogen from air, there are no other significant amounts of compounds remaining in the flue gas, other than the possibility of trace amounts (less than 1 ppm of the various syngas contaminant categories) and elemental mercury introduced with the syngas that had not been removed by the syngas cleanup system.

The oxy-fuel boiler will capture any heavy particulates generated from the oxy-fuel combustion process and wear products from inside the boiler (rust, refractory, and boiler wear products). Deposition of these particulates on boiler membrane surfaces and tubing will be removed via acoustic vibration. The boiler particulate capture system will recirculate these particulates back to the rotary kiln for capture in the melt.
Oxy-Fuel Combustion CO₂ Capture Process

In the rotary kiln catalytically enhanced oxy-fuel gasification and oxy-fuel combustion system, the flue gas exiting the oxy-fuel boiler is directed to a wet electrostatic precipitator (WESP). The WESP uses electrostatic forces to remove particulates from the flue gas. It also can remove any sub-micron particulates, aerosols, or fumes from the gas stream. Particulate collection occurs in the collector section of the WESP, which consists of an array of grounded tubes and high voltage discharge electrodes. High voltage is applied to the discharge electrodes to both charge the particulates and provide a high voltage field. The voltage on the discharge electrodes creates a corona discharge of electrons from high intensity ionization disks on the electrodes. This disk-in-tube geometry allows for the formation of a stable, intense, electrostatic field for particle charging. Electrons moving from the discharge disk to the collector tube, come in contact with particulates in the gas stream, putting a charge on the particulates. Once the particulates are charged, they deposit on the grounded collector tube. The particles are then intermittently flushed from the collector tube with a stream of water. The particulates collected are recirculated back to the rotary kiln for capture in the melt.

The flue gas then undergoes a multi-step carbon dioxide capture process. First the moisture in the flue gases exiting the WESP is removed by two stages of chillers to lower the dew point and form condensation (process water). The chillers will also capture any trace amounts of particulates that remained in the flue gas following the WESP removal process. The process water is treated by the plant water treatment system for use as condensate makeup and internal plant use.

Then the dry flue gas consisting of an extremely high CO₂ content is compressed to a pressure above 5 bar to overcome the CO₂ liquification triple point limitation. The pressurized flue gas is cryogenically treated to capture the CO₂ as a liquid. Any trace amounts of oxygen (6-8%) remaining in the flue gas is recirculated back to the rotary kiln for use in gasification. All other trace gases (CO₂, et. al.), if any, are recirculated back to the rotary kiln. Any elemental mercury (ppm) in the flue gas will be condensed within the CO₂ cryogenic capture process. The liquid mercury will be extracted from the bottom of the cryogenic vessel for by-product sales.

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

We claim:

1. A power plant comprising
an air separation unit arranged to separate oxygen from air and produce a stream of substantially pure liquid oxygen; or alternatively a liquid oxygen receiving, storage and supply system for substantially pure liquid oxygen;
rotary kiln gasifiers using enhanced catalytic oxy-fuel gasification to produce a synthesis gas and volcanic glass (frit); and
a synthesis gas (syngas) cleanup system for the removal of synthesis gas contaminants produced from the feedstock gasification; and
provisions for a multistage membrane hydrogen removal and capture system; and
an oxy-fuel fired boiler arranged to combust the synthesis gas in the presence of substantially pure oxygen gas, and to produce an exhaust gas comprising water and carbon dioxide; and
a carbon dioxide removal unit arranged to recover carbon dioxide gas from the exhaust gas, recycle a portion of the recovered carbon dioxide gas for passage through the rotary kiln gasifier, and liquefy the remainder of the recovered carbon dioxide gas for removal from the plant;
wherein said carbon dioxide removal unit is thermally integrated with the air separation unit or alternately the liquid oxygen storage and supply system by directing a stream of either liquid nitrogen or liquid oxygen to the carbon dioxide removal unit to liquefy the recovered carbon dioxide gas, the liquid oxygen/nitrogen thereby evaporating and if oxygen, forming cold oxygen gas which is heated prior to consumption in the rotary kiln and oxy-fuel fired boiler.

2. A power plant of claim 1, wherein the fuel is municipal solid waste, biomass, alternate wastes, coal, or hydrocarbon fuels.

3. A power plant of claim 1, wherein said air separation unit separates nitrogen from the air and produces a stream of cold, substantially pure nitrogen, and wherein the cold nitrogen is directed to cool the air prior to separation of oxygen and nitrogen.

4. A power plant of claim 1, wherein a multi-step syngas cleanup system removes a combination of particulate matter, sulfur compounds, chlorine compounds, nitrogen compounds, unreacted hydrocarbons (tars), and heavy metals compounds.

5. A power plant of claim 1, wherein high purity hydrogen is extracted from the synthesis gas following syngas cleanup

6. A power plant of claim 3, wherein pure liquid nitrogen is stored for further use

7. A power plant of claim 3, wherein the substantially pure nitrogen is at least 95 percent nitrogen in the form of a liquid.

8. A power plant of claim 1, wherein the substantially pure liquid oxygen is at least 95 percent oxygen.

9. A power plant of claim 1, wherein 100 percent of the recovered carbon dioxide is liquefied for removal from the plant.

10. A power plant of claim 1, wherein about 5 percent of the recovered carbon dioxide is recycled for passage through said rotary kiln gasifier prior to recovery and removal from the plant.

11. A power plant of claim 1 in a steady state/baseload operation, wherein an amount of carbon dioxide equal to 100 percent of the carbon dioxide produced from oxy-fuel gasification and oxy-fuel combustion is liquefied for removal from the plant.

12. A power plant of claim 1, wherein said air separation unit comprises a cooler arranged to cool the air prior to separation of oxygen, a compressor arranged to pressurize the air prior to separation of oxygen, and a distillation tower arranged to separate the oxygen from the air.

13. A power plant of claim 1, wherein said carbon dioxide removal unit comprises a compressor arranged to pressurize the recovered carbon dioxide gas, chillers arranged to remove water vapor from the recovered carbon dioxide gas, a cooler arranged to cool the recovered carbon dioxide gas, and a condenser arranged to liquefy the recovered carbon dioxide gas using the liquid nitrogen or liquid oxygen as a cooling source.

14. A power plant of claim 1, further comprising
a compressor arranged to pressurize the liquid oxygen from said distillation column prior to liquid oxygen storage prior to directing the liquid oxygen to said carbon dioxide removal unit to liquefy the recovered carbon dioxide gas; and
a compressor arranged to pressurize the liquid nitrogen from said distillation column prior to liquid nitrogen storage prior to directing the liquid nitrogen to said carbon dioxide removal unit to liquefy the recovered carbon dioxide gas; and
heat exchangers arranged such that the cold nitrogen gas or cold oxygen gas from said carbon dioxide removal unit is used to cool the chillers prior to carbon dioxide gas capture, and

15. A power plant of claim 14, wherein said liquid oxygen is pressurized to a pressure of at least 12 bar.

16. A power plant of claim 14, further comprising an oxy-fuel fired boiler arranged to produce steam and a flue gas comprised of water vapor and carbon dioxide gas, and further arranged to heat the cold oxygen gas produced by liquefaction or from liquid oxygen storage for use in the rotary kiln oxy-fuel gasifier and for use in the oxy-fuel combustion in the fired boiler.

17. A method of generating electricity with virtually zero pollutant emissions in a power plant having a steam turbine, said method comprising
combusting a synthesis gas as a fuel in the presence of substantially pure oxygen gas to produce an exhaust gas consisting essentially of water and carbon dioxide;
recovering carbon dioxide gas from the exhaust gas;
recycling a first portion of the recovered carbon dioxide gas for use in the rotary kiln oxy-fuel gasifier;
separating oxygen from air and producing a stream of substantially pure liquid oxygen or alternatively receiving and storing a substantially pure liquid oxygen supply;
separating nitrogen from air and producing a stream of substantially pure liquid nitrogen;
directing said substantially pure liquid oxygen or liquid nitrogen to liquify the recovered carbon dioxide gas for removal from the plant, the liquid oxygen thereby evaporating and forming oxygen gas; and
directing the oxygen gas to the rotary kiln oxy-fuel gasifier and the oxy-fuel fired boiler.

18. A method of claim 17, further comprising the steps of
separating nitrogen from the air and producing a stream of substantially pure nitrogen; and
directing the cold nitrogen to cool the recovered carbon dioxide gas for removal from the plant, and to cool the air prior to separation of oxygen and nitrogen.

19. A method of claim 17, further comprising the steps of compressing the substantially pure liquid oxygen prior to evaporation of the liquid
oxygen during liquefication of the remaining portion of the recovered carbon dioxide gas, thereby forming cold oxygen gas; and
heating the cold oxygen gas after directing the cold oxygen gas to cool the recovered carbon dioxide gas, and prior to passage of the oxygen gas into said rotary kiln oxy-fuel gasifier and oxy-fuel fired boiler.

20. A method of claim 16, wherein about 5 percent of the recovered carbon dioxide gas is recycled, and about 95 percent of the recovered carbon dioxide gas is liquefied for removal from the plant.

21. A method of claim 17, wherein during steady state/baseload operation, an amount of carbon dioxide equal to 100 percent of the carbon dioxide gas produced from oxy-fuel gasification and oxy-fuel combustion is liquefied for removal from the plant.

22. A method of claim 17, wherein the exhaust gas from the oxy-fuel fired boiler is converted to water, particulates, and recovered carbon dioxide.

23. A power plant of claim 1, wherein the exhaust gas from the oxy-fuel fired boiler is converted to water, particulates, and recovered carbon dioxide.
